(19) United States
(12) Patent Application Publication
(10) Pub. No.: US 2008/0126160 A1
(43) Pub. Date: May 29, 2008

(54) METHOD AND DEVICE FOR EVALUATING A TREND ANALYSIS SYSTEM

(76) Inventors: Hironori Takuechi, Yokohama-shi (JP); Daisuke Takuma, Sagamihara-shi (JP)

Correspondence Address: SHIMOKAJI & ASSOCIATES, P.C., 8911 RESEARCH DRIVE, IRVINE, CA, 92618, US

(21) Appl. No.: 11/947,114

(22) Filed: Nov. 29, 2007

(30) Foreign Application Priority Data
Aug. 12, 2006 (JP) 2006-332192

(51) Int. Cl. G06Q 10/00

(52) U.S. Cl. 705/7

(57) ABSTRACT

A device for evaluating a trend analysis system comprises: an allowable value input unit for receiving allowable values of false positives and allowable values of false negatives made by the trend analysis system; and an accuracy computation unit for computing an accuracy of the trend analysis system as a function of the allowable values of false positives and the allowable values of false negatives.

### BACKGROUND OF THE INVENTION

The present invention relates to trend analysis, and particularly relates to a self-evaluating trend analysis system.

Text mining is a type of trend analysis technique for analyzing trends and knowledge mainly by finding total sums of information pieces on keywords and dependency information between keywords contained in a collection of documents on the basis of a result of information extraction using natural language processing. In order to actually introduce a trend analysis system to a new place, language resources, such as user dictionaries, are provided and parameters are adjusted in accordance with conditions of the place so that the trend analysis system would be able to perform optimum analysis. However, such a tuning is typically performed on a trial-and-error basis and/or on an experience basis, and the current state of the art does not provide a technique for measuring the validity of a tuning result. Moreover, conventional tuning process also requires a lot of times and human resources.

In a case of a technique such as information extraction or retrieval from documents, a system or a technique is generally evaluated by executing information extraction or retrieval from documents to which correct answers of attributes and of relationships among them are previously given, and by comparing the execution result with a measure for an extraction result or a retrieval result. On the other hand, in a case of a trend analysis system aiming to extract relationships, knowledge and trends from a collection of documents, the evaluation on effectiveness of an obtained result is verified while actually using the system in an installed site. In other words, a mechanism has not been established for quantitative and qualitative evaluations of the conventional trend analysis system. Accordingly, when a certain component in a trend analysis system is improved, it is difficult to objectively estimate how much the system would be enhanced.

The following equation has been employed for computing an accuracy used in a conventional system evaluation:

$$Accuracy = \frac{RCE + NRCE}{TOTEXT} \qquad ( 1 )$$

where RCE is the number of relationships correctly extracted, NRCE is the number of non-relationships correctly extracted, and TOTEXT is the total number of extractions by a system.

Besides the above computation method taking correct determinations into consideration, there is another accuracy computation method taking wrong determinations into consideration. The wrong determinations include two types, that is, a false positive and a false negative. These two are treated as the same type of determination in the conventional accuracy, and thereby a difference among user-sites cannot be reflected in the accuracy. Japanese Patent Application Laid-open Publication No. 2005-237441 is an example of the related art.

### SUMMARY OF THE INVENTION

In one aspect of the present invention, a device for evaluating a trend analysis system comprises: an allowable value input unit for receiving allowable values of false positives and allowable values of false negatives made by the trend analysis system; and an accuracy computation unit for computing an accuracy of the trend analysis system as a function of the allowable values of false positives and the allowable values of false negatives.

In another aspect of the present invention, a method for evaluating a trend analysis system comprises the steps of: receiving relationships among attributes of data pieces in a data set, the relationships extracted by the trend analysis system; setting allowable ranges of errors for the relationships; and computing an accuracy for the trend analysis system as a function of the errors that fall within the allowable ranges.

In another aspect of the present invention, program product comprises a computer useable medium including a computer readable program, wherein the computer readable program when executed on a computer causes the computer to evaluate a trend analysis system by executing the steps of: receiving an allowable value of false positives, each false positive being a determination that data pieces are related although the data pieces are not related; receiving an allowable value of false negatives, each false negative being a determination that the data pieces are not related although the data pieces are related; and computing an accuracy for the trend analysis system.

These and other features, aspects and advantages of the present invention are better understood with reference to the following drawings, description and claims.

### BRIEF DESCRIPTION OF THE DRAWINGS

For a more complete understanding of the present invention and the advantage thereof, reference is now made to the following description taken in conjunction with the accompanying drawings.

FIG. 1 is a flowchart describing a process for evaluating a trend analysis system, in accordance with the present invention;

FIG. 2 is a diagrammatical illustration showing an area that includes values used for deriving weights satisfying the identity and possibilities of discrimination;

FIG. 3 is a pair of tables illustrating different evaluation results from a trend analysis system;

FIG. 4 is a flowchart describing a process for tuning a self-evaluation-based text mining system;

FIG. 5 is a diagrammatical illustration of a computer system that can be used to execute a method of the present invention;

FIG. 6 is a diagrammatical illustration and an associated table showing relationships between data pieces;

FIG. 7 is a diagrammatical illustration of results obtained from an evaluation performed by a trend analysis system on the data pieces of FIG. 6; and

FIG. 8 is a block diagram of an evaluation system, in accordance with the present invention.

### DETAILED DESCRIPTION OF THE PREFERRED EMBODIMENTS

The following detailed description is of the best currently contemplated modes of carrying out the invention. The description is not to be taken in a limiting sense, but is made merely for the purpose of illustrating the general principles of the invention, since the scope of the invention is best defined by the appended claims.

According to the present invention, a fair accuracy of a trend analysis system can be found without using relevance data containing correct information by providing threshold values that are allowable values (allowable ranges) of errors (false positives and false negatives) made by the trend analysis system, and that are easily understood by a user. The trend analysis system may extract relationships among attributes (for example, A and B have a relationship) from a data set or the like. A quantitative evaluation of the system itself may be executed by using an indicator in a case where relevance data containing correct information including information on known relationships among attributes is available. The evaluation indicator indicates how much relationship/trend information extracted from the data set by the system covers information in the relevance data containing correct information indicating the presence or absence of relationships. The quantitative evaluation of the system is performed by using a method of determining the evaluation indicator.

According to the present invention, penalty scores (weights) for the numbers of false positives and false negatives are derived from allowable ranges respectively set, by a user, for the numbers of false positives and false negatives, and then an accuracy is computed by using the penalty scores. If the penalty scores are given as arbitrary values, the system cannot be fairly evaluated, and thereby may perform an inappropriate tuning and feedback. For this reason, in the present invention, the penalty scores statistically appropriate for the relevance data containing correct information are figured out in order to fairly evaluate the system.

The trend analysis system of the present invention can find a fair accuracy not by using the relevance data containing correct information, but by using these penalty scores. When the system is changed by tuning parameters or updating a dictionary for text mining, the system performs an objective self-evaluation that shows how much the numbers of false positives and false negatives extracted by the system in terms of the presence or absence of relationship information or trend information (a binary assignment problem) are improved in comparison with the numbers desired by the user. Then, the system performs a self-tuning based on the evaluation result.

The present invention addresses the aforementioned technical problems by providing a device for objectively evaluating a trend analysis system that extracts relationships, trends and knowledge from a data set. In addition, the present invention provides a trend analysis system that extracts relationships among attributes of data pieces in a data set, and that executes a self-tuning of the system by performing a quantitative evaluation of the system. The self-evaluating trend analysis system performs a quantitative self-evaluation of functions of extracting relationship information pieces, trend information pieces and knowledge information pieces from a data set or the like, by using relevance data containing correct information indicating information on relationships among attributes, and trends and knowledge of the attributes, and that executes a tuning for the functions. The method, according to the invention, computes a system accuracy as an indicator for determining a quantitative result for system evaluation, by using weights that are computed from allowable ranges respectively set, by a user, for false positives and false negatives made by the system.

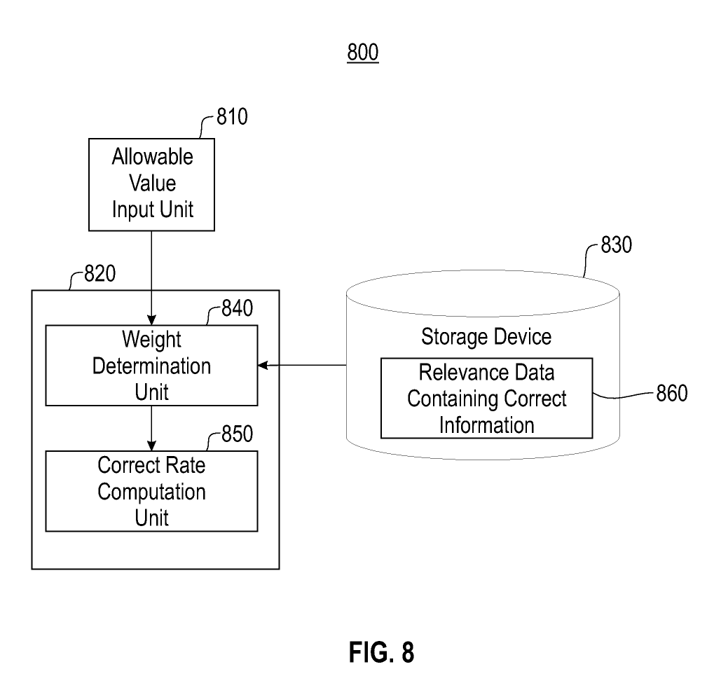

FIG. 8 shows a device 800 for evaluating a trend analysis system according to the present invention. The device according to the present invention is composed of an allowable value input unit 810 and an accuracy computation unit 820. The allowable value input unit 810 receives allowable values from the trend analysis system and may include false positives and false negatives. The false positive is a determination that data pieces are related to each other although the data pieces are not actually related. The false negative is a determination that data pieces are not related although the data pieces are actually related. The accuracy computation unit 820 computes an accuracy of the system, and may include a weight determination unit 840 and a computation unit 850.

The weight determination unit 840 reads relevance data containing correct information 860 that correctly indicates the presence or absence of relationships among data pieces included in a default data set stored in a storage device 830. The weight determination unit 840 then determines weights assigned to the numbers of false positives and false negatives made by the trend analysis system, from the allowable values for false positives and false negatives, by using the relevance data containing the correct information 860. The computation unit 850 computes the accuracy of the system by using the number of false positives, the weight assigned thereto, the number of false negatives, the weight assigned thereto, and the total number of data pieces, as explained in greater detail below. The accuracy thus computed by the accuracy computation unit 820 may be directly used as an evaluation result of the trend analysis system. Alternatively, a parameter adjusting unit (not shown) can be used to adjust parameters of the trend analysis system according to the computed accuracy so that the accuracy of the trend analysis system can be further increased.

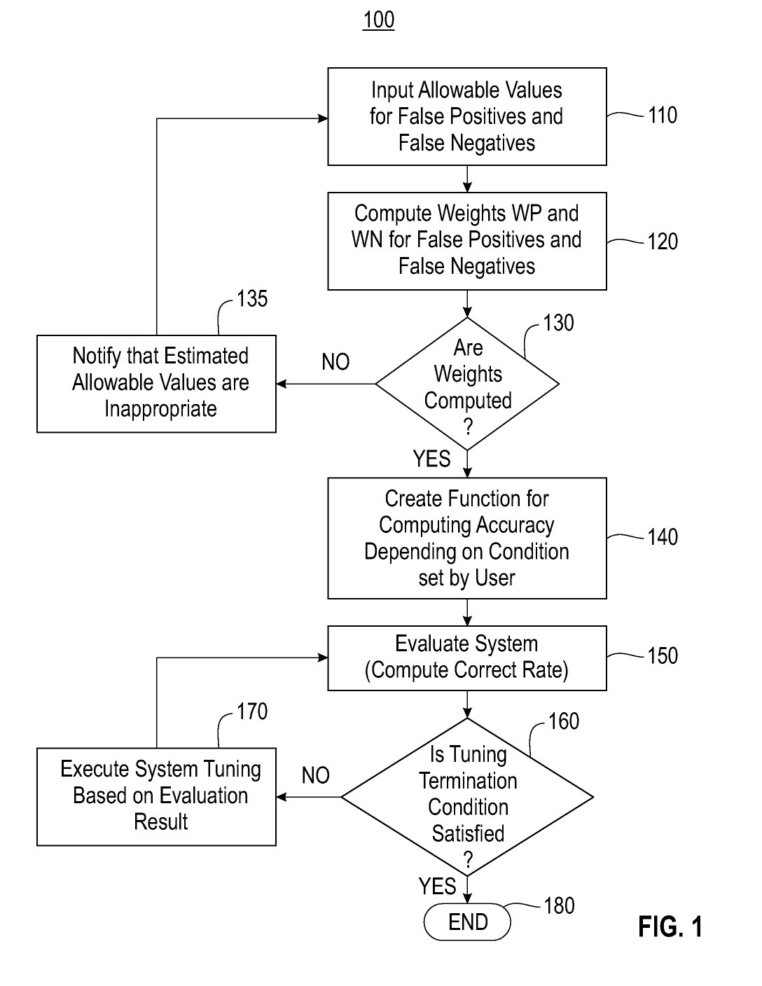

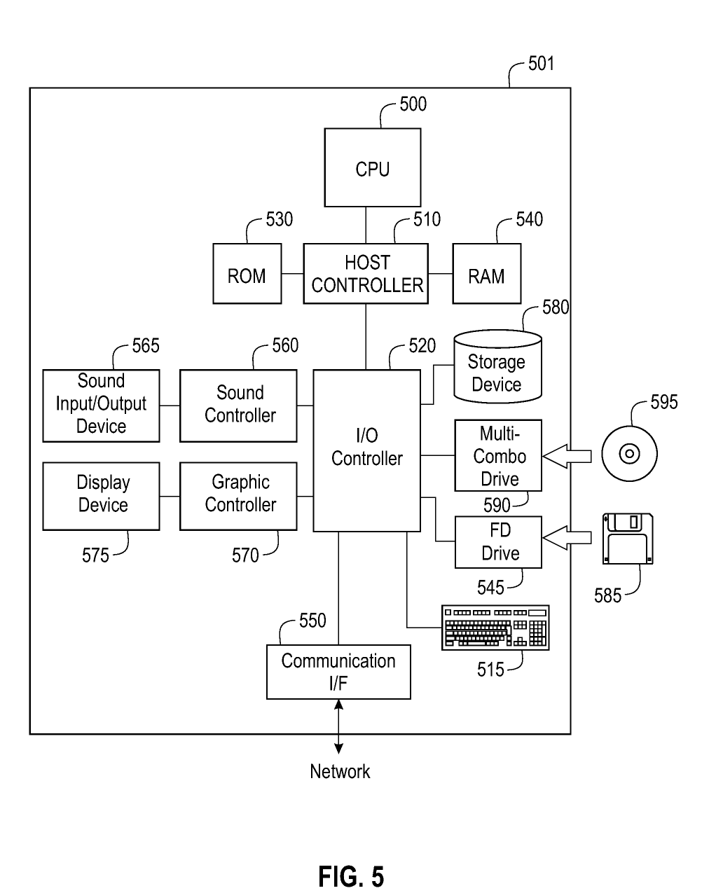

FIG. 1 shows a flowchart 100 for evaluating a trend analysis system according to an embodiment of the present invention. The evaluation process described in the flowchart 100 can be executed by a computing system, such as computer 501, shown in FIG. 5. In step 110, of FIG. 1, allowable ranges for false positives and false negatives may be inputted. In step 120, weights for computing an accuracy can be calculated, as described in greater detail below. In decision block 130, a judgment is made as to whether these weights have been successfully computed. If the weights have not been successfully computed, a notification that “the allowable ranges are inappropriate” is issued in step 135, and then the processing moves back to step 110 for inputting the allowable ranges again. If the weights have been successfully computed, at decision block 130, a function for computing an accuracy by using these weights can be generated for the trend analysis system in step 140.

In step 150, the accuracy of the trend analysis system can be computed by using the accuracy computation function generated in step 140. The trend analysis system is evaluated with the accuracy found by using the relevance data containing correct information and the weights. When only an evaluation result is desired, the processing may be terminated in step 150. When a system tuning is desired, the processing may continue on to decision block 160. In decision block 160, a judgment is made as to whether conditions for terminating the trend analysis system tuning are satisfied. If the termination conditions are not satisfied, the processing moves to step 170, and the trend analysis system tuning is performed. If the termination conditions are satisfied, the processing is terminated in step 180.

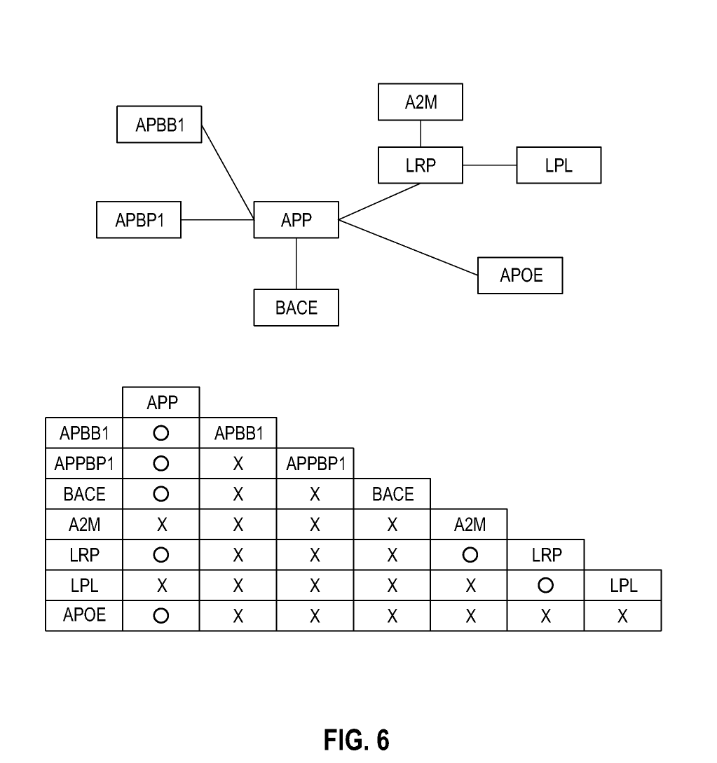

FIG. 6 shows an example of the relevance data containing correct information. For example, in a case of genetic data, relationships among genes in a particular set of genes can be provided in the form of a pathway. The present invention uses, as the relevance data containing correct information, knowledge data indicating the presence or absence of trend information. For example, FIG. 6 illustrates a pathway showing a part of relationships among genes in a set of genes related to Alzheimer's disease. Each pair of genes connected with an edge, such as gene APB1 and APP, have a relationship, whereas gene LPL and APP are not connected by an edge and, thus, do not have a relationship.

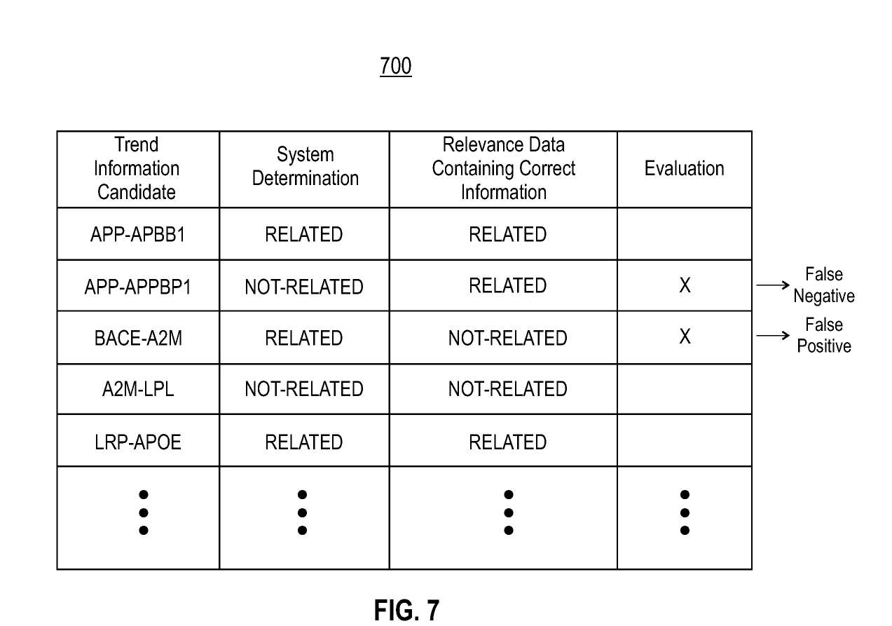

FIG. 7 shows a table 700 presenting the evaluation of the trend analysis system by using the relevance data containing correct information, shown in FIG. 6. The trend analysis system can be evaluated by comparing a determination outputted by the trend analysis system with the relevance data containing correct information, in regard to each item of a trend information candidate in the left-end column of the table 700. The table 700 includes items for which the trend analysis system makes correct determinations that agree with the relevance data containing correct information, and items for which the trend analysis system makes error determinations. The error determinations include false positive determinations, which are errors of determining that unrelated information pieces have a relationship, and include false negative determinations, which are errors of determining that related information pieces do not have a relationship.

In another exemplary embodiment of the present invention, the accuracy and the weights for error determination can be made according to the following method. The error determination weights may be used as ‘penalty scores’ computed for the numbers of errors in terms of the respective false positive and false negative made by the system. These weights can be found from the allowable values of the false positive and the false negative provided as inputs, by using the relevance data containing correct information that correctly indicates the presence or absence of relationships among data pieces in a preset data set. The accuracy of the trend analysis system can be computed by using these weights.

The accuracy (R) of a trend analysis system can be computed by using the following equation,

R=1−(P×WP+N×WN)/S (2)

where, in the numerator, the term ‘P’ denotes the number of false positives, the term ‘WP’ denotes the weight assigned to the number of false positives, the term ‘N’ denotes the number of false negatives, and the term ‘WN’ denotes the weight assigned to the number of false negatives. In the denominator, the term ‘S’ denotes the total number of data pieces. The weights assigned to the numbers of false positives and false negatives are determined to be values statistically appropriate for the relevance data containing correct information so that the trend analysis system can be fairly evaluated. Here, the ‘statistically appropriate value’ is taken to mean a value satisfying the following two conditions.

The first condition is an ‘identity condition’ in which there is determined to be no difference in a trend analysis system, with a probability not less than a predetermined probability, in a case where there is no difference between accuracies of the trend analysis system. The second condition is a ‘possibility of discrimination’ condition in which there is determined to be a difference in a trend analysis system, with a probability not less than the predetermined probability, in a case where there is a difference between accuracies of the trend analysis system. It should be noted that the possibilities of discrimination include a possibility of discrimination from the allowable value set for false positive errors (the allowable value of false positives), and a possibility of discrimination from the allowable value set for false negative errors (the allowable value of false negatives). A predetermined probability value used in statistics tests is about 95% or the like.

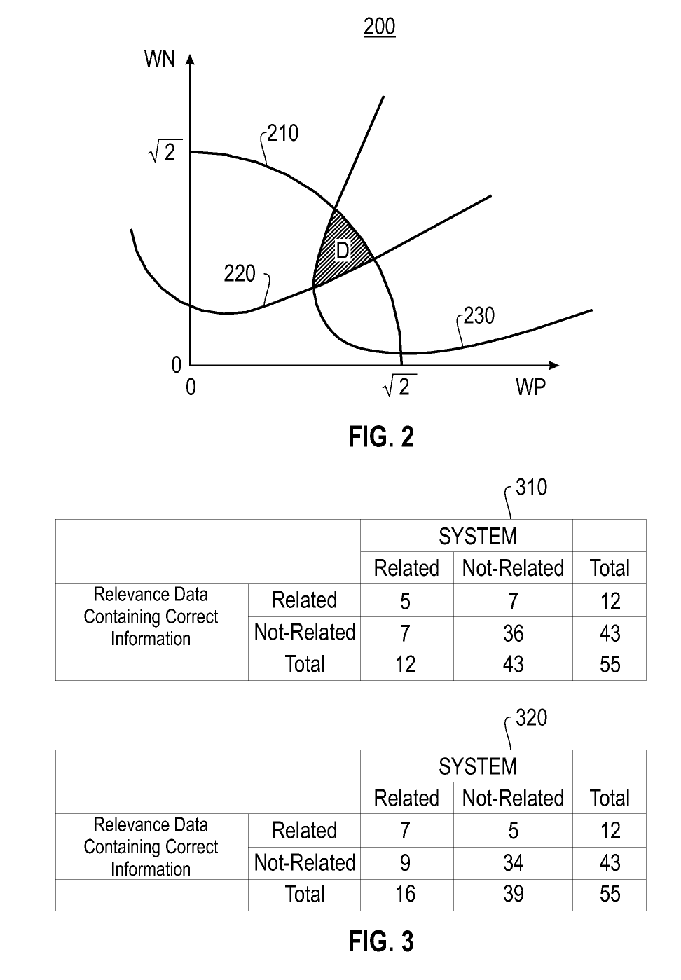

FIG. 2 is a graph 200 illustrating the identity and the possibilities of discrimination as areas defined by curves in the graph 200. The X-axis indicates the weight WP, the Y-axis indicates the weight WN, the area inside a line segment 210 indicates the identity, and the areas outsides line segments 220 and 230 indicate the probabilities of discrimination. The line segment 210 comprises a circle, and √2 is one example of the radius of this circle. Note that the line segments 220 and 230 are usually hyperbolas. An area ‘D’ comprises the intersection of the area inside the line segment 210, the area outside the line segment 220, and the area outside the line segment 230. The area D satisfied these conditions and indicates values of the weights. By employing certain weights indicated by this area D, the weights are determined as statistically appropriate values. Conversely, by taking values in this area D as the weights, the fair accuracy can be found without using the relevance data containing correct information, and thereby a trend analysis system can be evaluated objectively.

Table 310, in FIG. 3, illustrates the determination results of relationships among fifty five documents, which a trend analysis system may output by using relevance data containing correct information. Among the total of fifty five documents, out of twelve documents that are actually related to each other, the trend analysis system correctly determined that five documents are related, and incorrectly determined that the remaining seven documents are not related (i.e., false negatives). On the other hand, out of forty three documents that are not related, the trend analysis system correctly determined that thirty six documents are not related, and incorrectly determined that seven documents are related (i.e., false positives).

A revised table 320 can be generated by modifying the text mining parameters of the trend analysis system, or by upgrading a dictionary used for the text mining. Table 320 shows determination results of relationships among the documents, outputted by the modified or upgraded trend analysis system. As can be seen in these results, among the total of the fifty five documents, out of the twelve documents that are actually related to each other, the trend analysis system correctly determined that seven documents are related, and incorrectly determined that the remaining five documents are not related (false negatives). Additionally, among the forty three documents that are not actually related, the trend analysis system correctly determined that thirty four documents are not related, and incorrectly determined that nine documents are related (false positives). It can be appreciated that the results in the table 320, for the modified or upgraded trend analysis system, is an improvement over the results in the table 310 for the original trend analysis system. However, the accuracies R have the same value for the table 310 and for the table 320 when calculated using equation (1) above. That is, R=41/55=0.745 for both tables, and therefore it cannot be established that the modified or upgraded trend analysis system has been improved over the unmodified trend analysis system.

In accordance with an exemplary embodiment of the present invention, a weight of 1.20 for false positives and a weight of 0.742 for false negatives are computed and used in the equation for R. A user may specify, for example, an allowable value of four for false positives and an allowable value of two for false negatives. Then, by using the weight 1.20 for the number P of false positives and the weight 0.742 for the number N of false negatives, the accuracy for the modified or upgraded trend analysis system can be computed as

R=1−(P×1.20+N×0.742)/55 (3)

As a result, the accuracy for the unmodified trend analysis system, as determined by the table 310 is calculated as 0.752, and the accuracy of the modified or upgraded trend analysis system, as determined by the table 320 is calculated as 0.769. Thus, using allowable values for false positives and false negatives provided by the user, the trend analysis system can be verified as having been improved. It should be understood that, although the allowable values of false positives and false negatives have been inputted in the above example, an alternative method is to input a ratio between the allowable values of false positives and false negatives (which ratio would be ‘2’ in the above example). Alternatively, there may be other possible variations in the manner of giving such inputs without departing from the spirit and essential characteristics of the present invention.

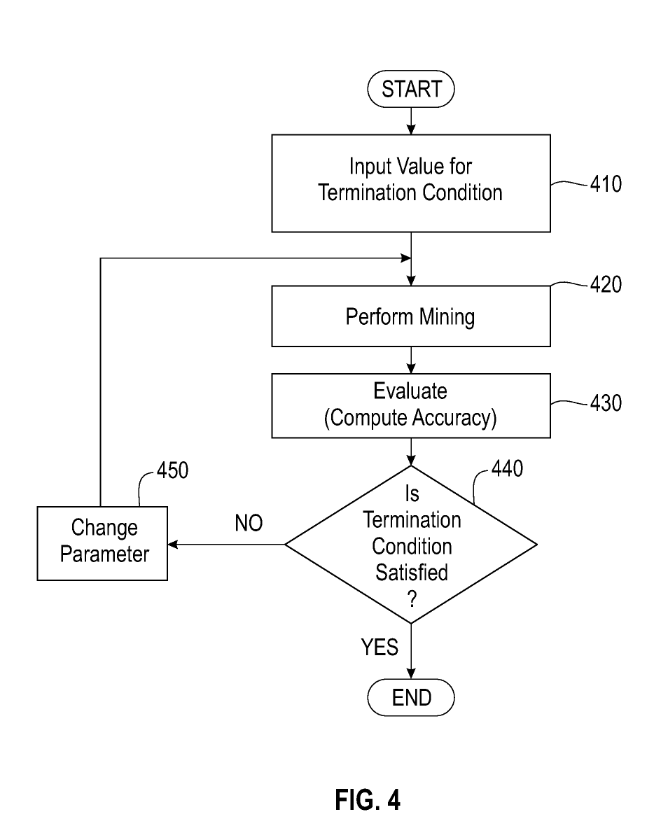

An automatic tuning of the trend analysis system can be achieved in such a way that the accuracy is increased by modifying parameters of the trend analysis system, according to the aforementioned evaluation of the trend analysis system improvement. For example, one method is to change a ‘confidence coefficient’ that is a parameter frequently used in a text mining system. FIG. 4 is a flow diagram showing a processing flow for tuning a self-evaluating text mining system incorporating an evaluation device of an embodiment of the present invention. In step 410, a termination condition may be inputted, such as, for example, an accuracy of not less than 90%. Next, in step 420, text mining is performed by using the relevance data containing correct information. In step 430, the result of text mining is evaluated, and thereby the accuracy is computed. If the computed accuracy satisfies the termination condition, in decision block 440, the tuning is terminated. If the computed accuracy does not satisfy the termination condition, in decision block 440, parameters are modified in step 450.

In step 450, one or more parameters, such as, for example, a confidence coefficient, can be automatically changed or modified according to an increase or decrease of the accuracy. For example, when a decrease of the confidence coefficient results in a corresponding increase of the accuracy, the confidence coefficient can be further decreased. Conversely, when an increase of the confidence coefficient results in a corresponding increase of the accuracy, the confidence coefficient can be further increased. In a situation where a decrease of the confidence coefficient results in a corresponding decrease of the accuracy, the confidence coefficient may then be increased, rather than further decreased. And in a situation where an increase of the confidence coefficient results in a corresponding decrease of the accuracy, the confidence coefficient can be decreased. This automatic tuning can be applied not only to the confidence coefficient but also to other parameters such as an upgrade of a dictionary of the trend analysis system.

The present invention can take the form of an entirely software embodiment or an embodiment containing both hardware and software elements. In an exemplary embodiment, the invention is implemented in software, which includes but is not limited to firmware, resident software, microcode, etc. Furthermore, the invention can take the form of a computer program product accessible from a computer-usable or computer readable medium providing program code for use by or in connection with a computer or any instruction execution system. For the purposes of this description, a computer-usable or computer readable medium can be any apparatus that can contain, store, communicate, propagate, or transport the program for use by on in connection with the instruction execution system, apparatus, or device. The medium can be an electronic, magnetic, optical, electromagnetic, infrared, or semiconductor system (or apparatus or device) or a propagation medium, as described below.

FIG. 5 shows a hardware configuration of a computer 501, functioning as an evaluation device, in an exemplary embodiment of the present invention. The computer 501 may be part of an information processing apparatus employed as a self-evaluating trend analysis system incorporating the method of the present invention. The computer 501 may include a CPU periphery unit having a CPU 500, a RAM 540, a ROM 530 and an I/O controller 520, which are mutually connected to each other with a host controller 510. In addition, the computer 501 may include a communication interface 550, a hard disk drive capable of reading from and writing to a storage device 580, a multi-combo drive 590 capable of reading from and a writing to disk-type medium 595 such as a CD/DVD, a floppy drive 545 capable of reading from and writing to a flexible disk 585, a sound controller 560 for driving a sound input/output device 565, and a graphic controller 570 for driving a display device 575, all of which are connected to the I/O controller 520.

The CPU 500 can operate in accordance with programs stored in the ROM 530, a BIOS, and the RAM 540, and thereby controls each component. The graphic controller 570 obtains image data, which the CPU 500 or the like generates in a buffer provided in the RAM 540, and causes the display device 575 to display images indicated by the image data. Alternatively, the graphic controller 570 may include a buffer for storing image data generated by the CPU 500 or the like. When the computer 501 functions as the self-evaluating trend analysis system including the evaluation device, the accuracy for the trend analysis system can be computed by using relevance data containing correct information recorded in the storage device 580.

For example, a termination condition may be inputted through an input device such as a keyboard 515. A text mining program and a program of the present invention can be loaded to a memory from the storage device 580, and the CPU 500 may execute the programs to compute the accuracy by reading the relevance data containing correct information recorded in the storage device 580. If the accuracy satisfies the termination condition, the tuning is terminated. If the accuracy does not satisfy the termination condition, parameters (such as a confidence coefficient) may be modified according to an increase or decrease of the accuracy. A tuning result is displayed on the display device 575.

The communication interface 550 may communicate with an external communication device via a network. When the computer 501 functions only as the evaluation device, the computer 501 may compute accuracy by receiving information for accuracy computation, which is outputted from an external trend analysis system, via the communication interface 550, and then may transmit the computation result to the external trend analysis system via the communication interface 550. The configurations of the embodiment of the present invention are applicable without any modification even when a connection is made with any type of network, including a wired network, a wireless network, and a short range wireless network such as an infrared network or Bluetooth. The storage device 580 stores codes and data of the program according to the embodiment of the present invention, applications, an operating system, and the like, which are used by the computer 501. The multi-combo drive 590 reads a program or data from the medium 595, such as CD/DVD. The programs and data read from the storage device 580 and the like are loaded to the RAM 540, and may thus be used by the CPU 500. The program, data targeted for a trend analysis, and relevance data containing correct information of the embodiment of the present invention may be provided from an external storage medium.

As the external storage medium, an optical recording medium such as a DVD or a PD, a magneto-optical recording medium such as an MD, a tape medium, a semiconductor memory such as an IC card can be used in addition to the flexible disk 585 and a CD-ROM. In addition, by using, as a recording medium, a storage device such as a hard disk or a RAM provided in a server system connected to a private communication network or the Internet, the program may be imported through the network. As can be understood from the forgoing configuration example, any type of apparatus can be used as hardware needed for implementing the embodiment of the present invention as long as it has a normal computing function. For example, a mobile terminal, a portable terminal and a household electrical appliance may also be used.

The operating system may support a graphical user interface (GUI) multi-window environment for operating on the computer 501. Examples of such an operating system include a Windows® operating system provided by Microsoft Corporation, a Mac OS® provided by Apple Incorporated, and a UNIX® system including an X Window System (for example, AIX® provided by International Business Machines Corporation). Moreover, the present invention can be implemented by using hardware, software and a combination of hardware and software. A typical example of the implementation using the combination of hardware and software is an implementation using a data processing system having a predetermined program. In this case, the predetermined program is loaded to and executed by the data processing system, and thereby the program causes the data processing system to be controlled so as to execute the processing according to an embodiment of the present invention. This program is composed of command groups that can be expressed by means of an arbitrary language, codes, and notations.

It should be understood that the system of FIG. 5 illustrates only an example of the hardware configuration of a computer that implements this embodiment, and other various configurations can be employed as long as this embodiment can be applied thereto. While the foregoing components have been described in the context of fully functioning computers and computer systems, those skilled in the art will appreciate that the various embodiments of the invention are capable of being distributed as a program product in a variety of forms, and that the invention applies equally regardless of the particular type of signal-bearing media used to actually carry out the distribution. Examples of signal-bearing media include, but are not limited to, the computer media described above and tangible transmission type media, such as tangible digital and analog communication links. It will further be appreciated by those skilled in the art that changes in these embodiments may be made without departing from the principles and spirit of the invention, the scope of which is defined by the appended claims.

What is claimed is:

1. A device for evaluating a trend analysis system, comprising:
an allowable value input unit for receiving allowable values of false positives and allowable values of false negatives made by the trend analysis system; and
an accuracy computation unit for computing an accuracy of the trend analysis system as a function of said allowable values of false positives and said allowable values of false negatives.

2. The device according to claim 1 wherein said accuracy computation unit comprises a weight determination unit for assigning weights to said values of false positives and said values of false negatives.

3. The device according to claim 2 wherein said weight determination unit further functions to read relevance data containing information correctly indicating the presence or absence of relationships among data pieces included in a default data set stored in a storage device.

4. The device according to claim 2 wherein said weight determination unit further functions to indicate whether said weights have been successfully computed.

5. The device according to claim 2 wherein said accuracy computation unit further comprises a computation unit for computing an accuracy for the trend analysis system by using said number of false positives, said assigned weights, said number of false negatives, and a total number of said data pieces.

6. The device according to claim 4, wherein said computed accuracy comprises a value computed by subtracting from unity a quotient derived by dividing said total number of data pieces into a numerator, said numerator found by multiplying said number of false positives by a first said weight and summing the product with said number of false negatives multiplied by a second said weight.

7. The device according to claim 2, wherein said weight determination unit functions to satisfy a condition for determining that there is no difference in the trend analysis system with a probability not less than a default probability in a case where there is no difference between accuracies of the trend analysis system.

8. The device according to claim 2, wherein said weight determination unit functions to satisfy a condition for determining that there is a difference in the trend analysis system with a probability not less than said default probability in a case where there is a difference between accuracies of the trend analysis system.

9. A method for evaluating a trend analysis system, comprising the steps of:
receiving relationships among attributes of data pieces in a data set, said relationships extracted by the trend analysis system;
setting allowable ranges of errors for said relationships; and
computing an accuracy for the trend analysis system as a function of said errors that fall within said allowable ranges.

10. The method according to claim 9 wherein said step of receiving relationships comprises the steps of:
receiving false positives, each said false positive being a determination that said data pieces are related to each other although not actually related; and
receiving false negatives, each said false negative being a determination that said data pieces are not related to each other although actually related.

11. The method according to claim 9 wherein the step of computing an accuracy comprises using a number of false positives, a weight assigned thereto, a number of false negatives, a weight assigned thereto, and a total number of said data pieces.

12. The method according to claim 11 wherein the step of using said number of false positives and said number of false negatives comprises the step of using a ratio between said number of false positives and said number of false negatives.

13. The method according to claim 9 wherein the step of step of computing an accuracy comprises the steps of:
reading relevance data containing correct information indicating the presence or absence of relationships among said data pieces ; and
assigning weights to a numbers of false positives and a number of false negatives made by the trend analysis system, said weights determined from allowable values for false positives and false negatives by using said relevance data.

14. The method according to claim 9 further comprising the step of performing a parameter tuning based on said computed accuracy.

15. The method according to claim 14 wherein said step of performing a parameter tuning comprises at least one of modifying a text mining parameter or upgrading a dictionary used for text mining.

16. The method according to claim 14 wherein said step of performing a parameter tuning comprises the step of modifying a confidence coefficient for the trend analysis system.

17. The method according to claim 14 further comprising the step of terminating said parameter tuning when said computed accuracy satisfies a termination condition.

18. A program product comprising a computer useable medium including a computer readable program, wherein the computer readable program when executed on a computer causes the computer to evaluate a trend analysis system by executing the steps of:
receiving an allowable value of false positives, each said false positive being a determination that data pieces are related although said data pieces are not related;
receiving an allowable value of false negatives, each said false negative being a determination that said data pieces are not related although said data pieces are related; and
computing an accuracy for the trend analysis system.

19. The program product according to claim 18 wherein said accuracy computing step comprises the steps of:
reading relevance data containing correct information indicating the presence or absence of relationships among data pieces included in a default data set stored in a storage device; and
determining weights assigned to the number of false positives and number of false negatives made by the system, from said allowable values for false positives and said allowable values for false negatives by using said relevance data containing correct information.

20. The program product according to claim 19 wherein said step of computing an accuracy for the trend analysis system comprises using said number of false positives, said weight assigned to said false positives number, said number of false negatives, said weight assigned to said false negatives number, and a total number of said data pieces.
